(19) United States
(12) Patent Application Publication
(10) Pub. No.: US 2024/0160369 A1
(43) Pub. Date: May 16, 2024

(54) MEMORY CONTROLLER AND OPERATION METHOD THEREOF, MEMORY SYSTEM AND ELECTRONIC DEVICE

(71) Applicant: Yangtze Memory Technologies Co., Ltd., Wuhan (CN)

(72) Inventors: Huadong HUANG, Wuhan, Hubei (CN); Youxin HE, Wuhan, Hubei (CN)

(73) Assignee: Yangtze Memory Technologies Co., Ltd., Wuhan (CN)

(21) Appl. No.: 18/090,435

(22) Filed: Dec. 28, 2022

(30) Foreign Application Priority Data
Nov. 16, 2022 (CN) 202211436399.9

(51) Int. Cl. G06F 3/06

(52) U.S. Cl. CPC G06F 3/064; G06F 3/0604; G06F 3/0659; G06F 3/0679

(57) ABSTRACT

Implementations of the present disclosure provide a memory controller and a method operating the same. The method can include providing a plurality of virtual blocks to be collected, acquiring identification information of valid memory cell sets in the virtual blocks to be collected, determining valid memory cell sets for storing cold data in the virtual blocks to be collected according to the identification information, wherein the identification information includes hot and cold attributes indicating stored data in the valid memory cell sets, and, if the sum of the numbers of the valid memory cell sets for storing cold data in the plurality of virtual blocks to be collected is greater than or equal to the number of memory cell sets of a target virtual block, filling the target virtual block with cold data of the valid memory cell sets in the plurality of virtual blocks to be collected.

### INCORPORATION BY REFERENCE

This present application claims the benefit of Chinese Patent Application No. 202211436399.9 filed on Nov. 16, 2022, which is incorporated herein by reference in its entirety.

### BACKGROUND

### Technical Field

Implementations of the present disclosure relates to the technical field of semiconductors, in particular, to a memory controller and an operation method thereof, a memory system and an electronic device.

### Description of the Related Art

Garbage Collection (GC) can include the following three steps: selecting a source virtual block; finding valid data from the source virtual block; and filling a target virtual block with the valid data. In this way, all the stored data in the source virtual block can be erased to obtain a new available virtual block.

The stored data can be divided into hot data and cold data according to access frequencies. The access frequency of the hot data is greater than that of the cold data. If the hot data and the cold data are not distinguished, and the hot data and the cold data are stored together, the hot data and the cold data are moved at the same frequency in the GC process, resulting in an increase in the cost of GC and a decrease in the durability of a memory.

### SUMMARY

In view of this, implementations of the present disclosure provide a memory controller and an operation method thereof, a memory system and an electronic device in order to solve at least one technical problems in the prior art.

In a first aspect, an implementation of the present disclosure provides an operation method of a memory controller. The operation method can include providing a plurality of virtual blocks to be collected, acquiring identification information of valid memory cell sets in the virtual blocks to be collected, determining valid memory cell sets for storing cold data in the virtual blocks to be collected according to the identification information, wherein the identification information comprises hot and cold attributes indicating stored data in the valid memory cell sets, and, if the sum of the numbers of the valid memory cell sets for storing cold data in the plurality of virtual blocks to be collected is greater than or equal to the number of memory cell sets of a target virtual block, filling the target virtual block with cold data of the valid memory cell sets in the plurality of virtual blocks to be collected.

In some implementations, before the acquiring identification information of valid memory cell sets in the virtual blocks to be collected, the operation method can further include acquiring logic cell address and corresponding physical cell addresses of memory cell sets in the virtual blocks to be collected, and determining the valid memory cell sets from the memory cell sets in the virtual blocks to be collected according to the physical cell addresses.

In some implementations, the operation method further includes determining collection priorities of the various virtual blocks to be collected according to the numbers of the valid memory cell sets in the various virtual blocks to be collected.

In some implementations, before the providing a plurality of virtual blocks to be collected, the operation method further includes acquiring the number of valid memory cell sets in a memory virtual block, and determining the plurality of virtual blocks to be collected from the memory virtual block according to the number of the valid memory cell sets in the memory virtual block.

In some implementations, before the providing a plurality of virtual blocks to be collected, the operation method further includes acquiring the number of valid memory cell sets in a memory virtual block, and determining the plurality of virtual blocks to be collected from the memory virtual block according to a first ratio of the number of the valid memory cell sets in the memory virtual block to the number of memory cell sets in the memory virtual block.

In some implementations, the determining the plurality of virtual blocks to be collected from the memory virtual block according to a first ratio of the number of the valid memory cell sets in the memory virtual block to the number of memory cell sets in the memory virtual block includes, if the first ratio is less than a first preset value, determining the memory virtual block as the virtual block to be collected.

In some implementations, before the providing a plurality of virtual blocks to be collected, the operation method further includes acquiring the number of valid memory cell sets in a memory virtual block and the number of valid memory cell sets for storing cold data in the memory virtual block, and determining the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

In some implementations, the determining the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block includes, if the second ratio is less than a background garbage collection threshold, determining the memory virtual block as the virtual block to be collected.

In some implementations, the valid memory cell sets include a first valid memory cell subset and a second valid memory cell subset, and the first valid memory cell subset is used for storing user data, and the second valid memory cell subset is used for storing the identification information.

In a second aspect, an implementation of the present disclosure provides a memory controller. The memory controller is configured to provide a plurality of virtual blocks to be collected, acquire identification information of valid memory cell sets in the virtual blocks to be collected, determine valid memory cell sets for storing cold data in the virtual blocks to be collected according to the identification information, wherein the identification information comprises hot and cold attributes indicating stored data in the valid memory cell sets, and, if the sum of the numbers of the valid memory cell sets for storing cold data in the plurality of virtual blocks to be collected is greater than or equal to the number of memory cell sets of a target virtual block, fill the target virtual block with cold data of the valid memory cell sets in the plurality of virtual blocks to be collected.

In some implementations, the memory controller is configured to acquire logic cell address and corresponding physical cell addresses of memory cell sets in the virtual blocks to be collected, and determine the valid memory cell sets from the memory cell sets in the virtual blocks to be collected according to the physical cell addresses.

In some implementations, the memory controller is configured to determine collection priorities of the various virtual blocks to be collected according to the numbers of the valid memory cell sets in the various virtual blocks to be collected.

In some implementations, the memory controller is configured to acquire the number of valid memory cell sets in a memory virtual block, and determine the plurality of virtual blocks to be collected from the memory virtual block according to the number of the valid memory cell sets in the memory virtual block.

In some implementations, the memory controller is configured to acquire the number of valid memory cell sets in a memory virtual block, and determine the plurality of virtual blocks to be collected from the memory virtual block according to a first ratio of the number of the valid memory cell sets in the memory virtual block to the number of memory cell sets in the memory virtual block.

In some implementations, the memory controller is configured to, if the first ratio is less than a first preset value, determine the memory virtual block as the virtual block to be collected.

In some implementations, the memory controller is configured to acquire the number of valid memory cell sets in a memory virtual block and the number of valid memory cell sets for storing cold data in the memory virtual block, and determine the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

In some implementations, the memory controller is configured to, if the second ratio is less than a background garbage collection threshold, determine the memory virtual block as the virtual block to be collected.

In some implementations, the valid memory cell sets include a first valid memory cell subset and a second valid memory cell subset, and the first valid memory cell subset is used for storing user data; and the second valid memory cell subset is used for storing the identification information.

In a third aspect, an implementation of the present disclosure provides a memory system. The memory system includes a memory and the memory controller in the above-mentioned technical solution.

In a fourth aspect, an implementation of the present disclosure provides an electronic device. The electronic device includes the memory system in the above-mentioned technical solution.

Implementations of the present disclosure provide a memory controller and an operation method thereof, a memory system and an electronic device. The operation method includes providing a plurality of virtual blocks to be collected, acquiring identification information of valid memory cell sets in the virtual blocks to be collected, determining valid memory cell sets for storing cold data in the virtual blocks to be collected according to the identification information, wherein the identification information includes hot and cold attributes indicating stored data in the valid memory cell sets, and, if the sum of the numbers of the valid memory cell sets for storing cold data in the plurality of virtual blocks to be collected is greater than or equal to the number of memory cell sets of a target virtual block, filling the target virtual block with cold data of the valid memory cell sets in the plurality of virtual blocks to be collected.

In the implementations of the present disclosure, in a garbage collection process, a distribution of the cold data in the virtual blocks to be collected is analyzed, under the condition of satisfying that one target virtual block can be fully filled with the cold data stored in the plurality of virtual blocks to be collected, the target virtual block is filled with the cold data stored in the plurality of virtual blocks to be collected (that is, the cold data is gathered), so that the cold data and hot data in a memory can be separately stored, thus realizing hot and cold separation for the data stored in the memory by using the garbage collection process, and further improving the durability of the memory and keeping the writing performance of the memory after long-time use.

### BRIEF DESCRIPTION OF THE DRAWINGS

Various implementations of this disclosure that are proposed as examples will be described in detail with reference to the following figures, wherein like numerals reference like elements, and wherein:

FIG. 1 is a flow block diagram of garbage collection;

FIG. 2 is a schematic flow diagram of an operation method of a memory controller provided by an implementation of the present disclosure;

FIG. 3 is a schematic flow diagram of analyzing a data distribution provided by an implementation of the present disclosure;

FIG. 4 is a block diagram of constitutions of a valid memory cell set provided by an implementation of the present disclosure;

FIG. 5 is a flow block diagram of determining valid memory cell sets for storing cold data provided by an implementation of the present disclosure;

FIG. 6 is a schematic diagram of a trigger condition for gathering cold data provided by an implementation of the present disclosure;

FIG. 7 is a schematic diagram of determining virtual blocks to be collected provided by an implementation of the present disclosure;

FIG. 8 is a schematic diagram of a memory system provided by an implementation of the present disclosure;

FIG. 9A is a schematic diagram of a memory card provided by an implementation of the present disclosure; and

FIG. 9B is a schematic diagram of a solid state drive provided by an implementation of the present disclosure.

### DETAILED DESCRIPTION OF THE PREFERRED IMPLEMENTATIONS

The technical solutions in the implementations of the present disclosure will be described clearly and completely below in combination with the implementations and drawings of the present disclosure. Apparently, the described implementations are only part of the implementations of the present disclosure, not all implementations. Based on the implementations in present disclosure, all other implementations obtained by those of ordinary skill in the art without creative work shall fall within the protection scope of the present disclosure.

In the following description, a lot of specific details are given in order to provide a more thorough understanding of the present disclosure. However, it is obvious to those skilled in the art that the present disclosure can be implemented without one or more of these details. In other examples, in order to avoid confusion with the present disclosure, some technical features well known in the art are not described. That is, not all the features of the actual implementations are described here, and the well-known functions and structures are not described in detail.

In order to fully understand the present disclosure, detailed steps and detailed structures will be provided in the following descriptions to explain the technical solutions of the present disclosure. The preferred implementations of the present disclosure are described in detail as follows. However, in addition to these detailed descriptions, the present disclosure can also have other implementations.

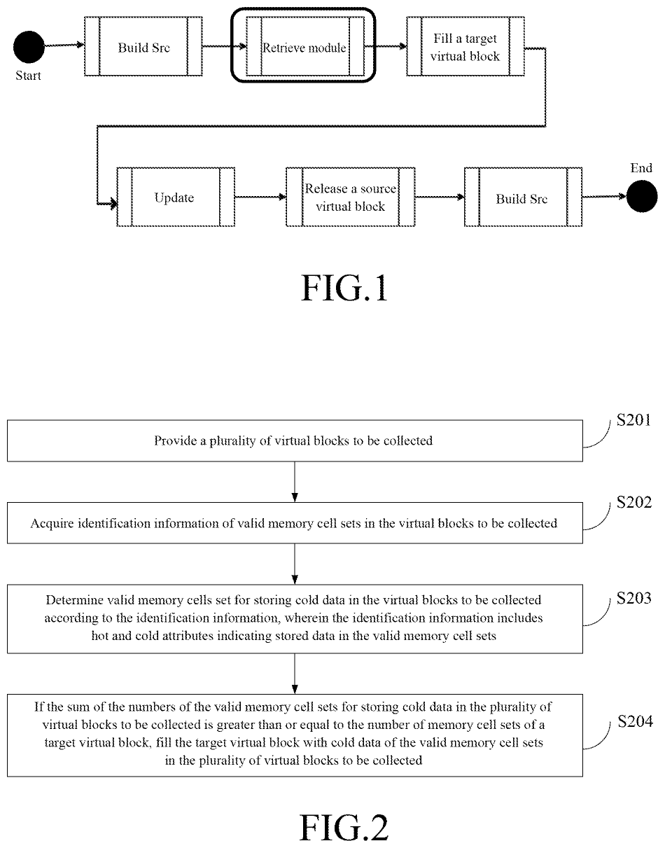

Referring to FIG. 1, FIG. 1 is a flow block diagram of garbage collection. As shown in FIG. 1, each garbage collection process starts; a catalog is built (Build Src); valid data is found from a source virtual block using a retrieve module; a target virtual block is filled with the valid data; a logic cell address and physical cell address mapping table (GCSA) of the valid data is updated; a catalog is built after the source virtual block is released; and the garbage collection process ends.

As mentioned above, in the garbage collection process, the valid data in the source virtual block is moved to the target virtual block without distinguishing hot data and cold data. In the garbage collection process, hot data and cold data are moved at the same frequency, resulting in an increase in the cost of garbage collection and a decrease in the durability of a memory.

In view of this, implementations of the present disclosure provide a memory controller and an operation method thereof, a memory system and an electronic device. In the garbage collection process, a distribution of the cold data in the virtual blocks to be collected is analyzed; under the condition of satisfying that one target virtual block can be fully filled with the cold data stored in the plurality of virtual blocks to be collected, the target virtual block is filled with the cold data stored in the plurality of virtual blocks to be collected (that is, the cold data is gathered), so that the cold data and hot data in a memory can be separately stored, thus realizing hot and cold separation for the data stored in the memory by using the garbage collection process, and further improving the durability of the memory and keeping the writing performance of the memory after long-time use.

Referring to FIG. 2, FIG. 2 is a schematic flow diagram of an operation method of a memory controller provided by an implementation of the present disclosure. As shown in FIG. 2, the operation method of a memory controller provided by the implementation of the present disclosure includes the following steps:

Step S201: provide a plurality of virtual blocks to be collected;

Step S202: acquire identification information of valid memory cell sets in the virtual blocks to be collected;

Step S203: determine valid memory cell sets for storing cold data in the virtual blocks to be collected according to the identification information, wherein the identification information includes hot and cold attributes indicating stored data in the valid memory cell sets; and

Step S204: if the sum of the numbers of the valid memory cell sets for storing cold data in the plurality of virtual blocks to be collected is greater than or equal to the number of memory cell sets of a target virtual block, fill the target virtual block with cold data of the valid memory cell sets in the plurality of virtual blocks to be collected.

An implementation of the present disclosure also provides a processing method of data. The processing method of data can be used for processing the stored data of the memory. Therefore, the processing method of data can include the operation method of a memory controller.

In this implementation of the present disclosure, in step S201, a plurality of virtual blocks to be collected are provided.

The memory here is usually composed of memory blocks. The memory blocks with the same block ID on different dies and different storage planes are put together to form a Virtual Block (VB). Firmware typically manages the memory in unit of VB.

The virtual block to be collected refers to a Virtual Block (VB) that needs to be collected in this garbage collection when the memory triggers garbage collection. In step S201, when the memory controller triggers garbage collection, the virtual blocks to be collected are determined in the memory, so as to collect the virtual blocks to be collected.

It should be noted that the general garbage collection process refers to selecting a source virtual block from all virtual blocks, finding valid data from the source virtual block, filling a target virtual block with the valid data, and releasing the source virtual block. The garbage collection is mainly performed on the valid data in the source virtual block. In the operation method provided by this implementation of the present disclosure, the garbage collection is performed on the cold data in the plurality of virtual blocks to be collected. A range of the plurality of virtual blocks to be collected provided by this implementation of the present disclosure can be less than or equal to the source virtual block.

In some implementations, before the identification information of valid memory cell sets in the virtual blocks to be collected is acquired, the operation method further includes acquire Logic Cell Addresses (LCA) and corresponding Physical Cell Addresses (PCA) of memory cell sets in the virtual blocks to be collected, and determine the valid memory cell sets from the memory cell sets in the virtual blocks to be collected according to the PCAs.

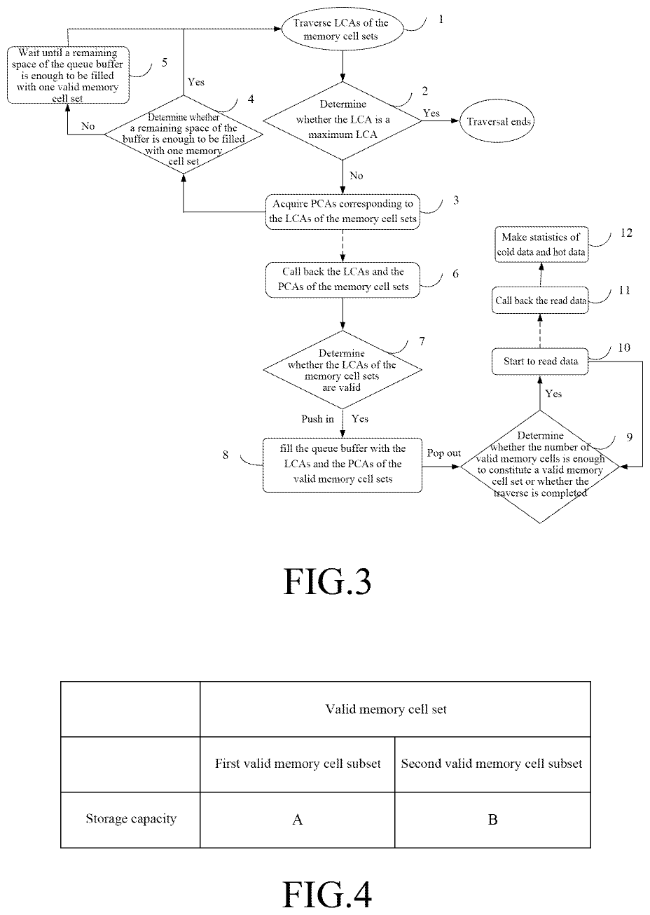

Referring to FIG. 3, FIG. 3 is a schematic flow diagram of analyzing a data distribution provided by an implementation of the present disclosure. As shown in FIG. 3, in step 1, traverse all LCAs of the memory cell sets. The LCAs of the memory cell sets of the virtual blocks to be collected are traversed here.

In step 2, determine whether the LCA is a maximum LCA (Is max LCA), that is, it is determined whether the traverse of the LCAs of the memory cell sets is completed; if it is determined that the traverse of the LCAs of the memory cell sets has been completed (that is, “Yes” as shown in FIG. 3), the traverse ends; and if it is determined that the traverse of the LCAs of the memory cell sets has not been completed (that is, “No” as shown in FIG. 3), step 3 is executed.

In step 3, acquire PCAs corresponding to the LCAs of the memory cell sets.

A buffer can be filled with the LCAs and the corresponding PCAs of the memory cell sets. However, the buffer has a limited storage capacity. If the buffer is not full, the buffer can continue to be filled; if the buffer has been full, the buffer can be filled with the LCA and the corresponding PCA of the next memory cell set only after the LCA and the corresponding PCA in the buffer are read out (that is, after the LCA and the corresponding PCA in the buffer are written to a queue buffer).

In step 4, determine whether a remaining space of the buffer is enough to be filled with one memory cell set, that is, it is determined whether a remaining space of the buffer is enough to be filled with the LCA and the corresponding PCA of one memory cell set; if it is determined that the remaining space of the buffer is enough to be filled with one memory cell set (that is, “Yes” as shown in FIG. 3), step 1 is executed; and if it is determined that the remaining space is not enough to be filled with one memory cell set (that is, “No” as shown in FIG. 3), step 5 is executed.

In step 5, wait for the remaining space of the queue buffer is enough to be filled with one valid memory cell set. In this way, if the remaining space of the queue buffer is enough to be filled with one valid memory cell set, after the queue buffer is filled with the LCAs and the corresponding PCAs of the valid memory cell sets in the buffer, the remaining space vacated in the buffer is enough to be filled with one memory cell set.

It should be noted that the buffer is filled with the LCAs and the corresponding PCAs of the memory cell sets; the queue buffer is filled with the LCAs and corresponding PCAs of the valid memory cell sets selected from the buffer; and a retrieve buffer is filled with the LCAs and corresponding PCAs of the valid memory cell sets for storing cold data selected from the queue buffer. Here, the buffer, the queue buffer and the retrieve buffer have limited storage capacities. When the buffer is full, the buffer can continue to be filled only after the LCAs and corresponding PCAs of the valid memory cell sets in the buffer are written to the queue buffer to vacate a remaining space in the buffer. Similarly, when the queue buffer is full, the queue buffer can continue to be filled only after the LCAs and corresponding PCAs of the valid memory cell sets for storing cold data in the queue buffer are written to the retrieve buffer to vacate a remaining space in the queue buffer.

In Step 6, call back the LCAs and the PCAs of the memory cell sets (LCA to PCA Callback). Here, the LCAs and the PCAs of the memory cell sets are called back for the next step.

In step 7, determine whether the LCAs of the memory cell sets are valid (Is LCA valid), that is, it is determined whether data corresponding to the LCAs of the memory cell sets is valid; if it is determined that the LCAs of the memory cell sets are valid (that is, “Yes” as shown in FIG. 3), step 8 is executed; and if it is determined that the LCAs of the memory cell sets are invalid, it is not needed to fill the queue buffer with the LCAs of the invalid memory cell sets.

In step 8, fill the queue buffer with the LCAs and the PCAs of the valid memory cell sets, i.e., to push into queue (Push).

The queue buffer can be filled with the LCAs and the corresponding PCAs of the valid memory cell sets here. However, the queue buffer has a limited storage capacity. If the queue buffer is not full, the queue buffer can continue to be filled; and if the queue buffer has been full, the queue buffer can be filled with the LCA and the corresponding PCA of the next valid memory cell set only after the LCA and the corresponding PCA in the queue buffer are read out (that is, after the LCA and the corresponding PCA in the buffer are written to the retrieve buffer).

In step 9, after popping out of the queue (POP), determine whether the number of valid memory cells constitutes a valid memory cell set or whether the traverse is completed, that is, determine whether the number of valid memory cell sets popped out of the queue constitutes a valid memory cell set or whether the traverse of the valid memory cell sets in the queue buffer is completed; if it is determined that the number of valid memory cell sets popped out of the queue constitutes a valid memory cell set or it is determined that the traverse of the valid memory cell sets in the queue buffer has been completed (that is, “Yes” as shown in FIG. 3), step 10 is executed. If it is determined that the number of valid memory cell sets popped out of the queue cannot constitute a valid memory cell set or it is determined that the traverse of the valid memory cell sets in the queue buffer has not been completed, wait for a period of time until the number of valid memory cell sets popped out of the queue constitutes a valid memory cell set or until the traverse of the valid memory cell sets in the queue buffer is completed.

In this implementation of the present disclosure, in step S202, identification information of valid memory cell sets in the virtual blocks to be collected is acquired.

As shown in FIG. 3, in step 10, start to read data. In step 11, call back the read data (Read Callback). The read data is called back to acquire the identification information of the valid memory cell sets.

In some implementations, the valid memory cell sets include a first valid memory cell subset and a second valid memory cell subset; and the first valid memory cell subset is used for storing user data; and the second valid memory cell subset is used for storing the identification information.

Referring to FIG. 4, FIG. 4 is a block diagram of constitutions of a valid memory cell set provided by an implementation of the present disclosure. As shown in FIG. 4, the valid memory cell sets include the first valid memory cell subset for storing user data, a storage capacity of which can be A; and the valid memory cell sets also include a second valid memory cell subset for storing identification information, a storage capacity of which can be B. Here, the storage capacity of the first valid memory cell subset here is greater than that of the second valid memory cell subset, that is, A>B.

The identification information here can include information for determining whether valid data currently stored in the valid memory cell set is hot data or cold data. For each data of the memory having storage capacity A, there will be an additional idle space with storage capacity B for storing the identification information. This implementation of the present disclosure does not make special restrictions on ratios of the storage capacity of the valid memory cell set to the storage capacities of the first valid memory cell subset and the second valid memory cell subset.

In this implementation of the present disclosure, in step S203, the valid memory cell sets for storing cold data in the virtual blocks to be collected are determined according to the identification information, wherein the identification information includes hot and cold attributes indicating stored data in the valid memory cell sets.

Still as shown in FIG. 3, in step 12, make statistics of cold data and hot data (Statistic cold/hot data in read callback). A distribution of the hot data and the cold data in the virtual blocks to be collected can be determined according to the identification information.

Referring to FIG. 5, FIG. 5 is a flow block diagram of determining valid memory cell sets for storing cold data provided by an implementation of the present disclosure. As shown in FIG. 5, the virtual blocks to be collected store data and Page Table Entry (PTE) bitmaps, and a PTE table is obtained according to the PTE bitmaps. The LCAs and the PCAs of the valid memory cell sets in the virtual blocks to be collected are found in the PTE table, and are recorded in the queue buffer. By reading the data corresponding to the LCAs of the memory cell sets, the LCAs and the PCAs of the determined valid memory cell sets for storing cold data are recorded in the retrieve buffer. Here, the reading of the data corresponding to the LCAs of the memory cell sets includes: read the user data stored in the first memory cell subset and read the identification information stored in the second memory cell subset, so as to determine the cold and hot attributes of the data stored in the memory cell sets.

In this implementation of the present disclosure, in step S204, if the sum of the numbers of the valid memory cell sets for storing cold data in the plurality of virtual blocks to be collected is greater than or equal to the number of memory cell sets of a target virtual block, the target virtual block is filled with cold data of the valid memory cell sets in the plurality of virtual blocks to be collected.

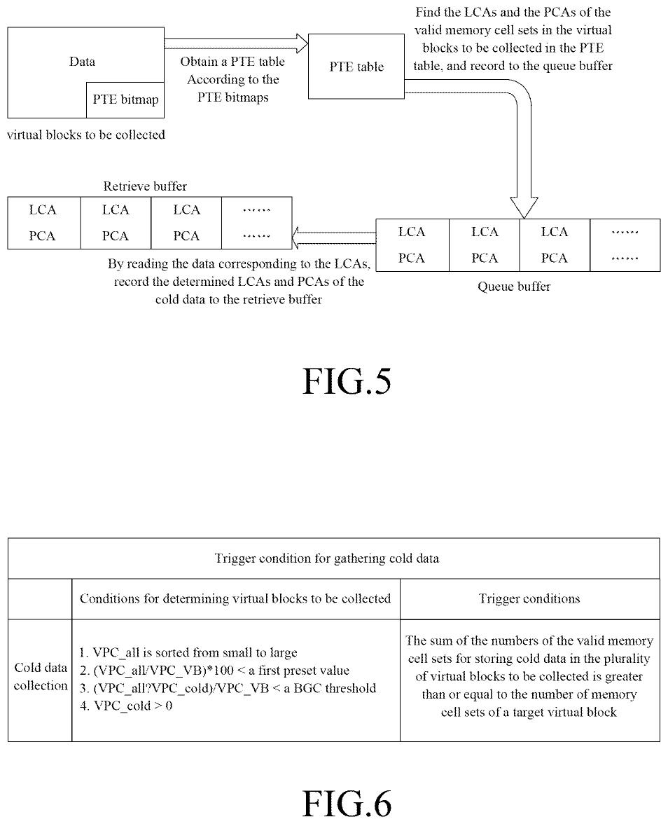

Referring to FIG. 6, FIG. 6 is a schematic diagram of a trigger condition for gathering cold data provided by an implementation of the present disclosure. As shown in FIG. 6, the trigger condition for gathering cold data is as follows: if the sum of the numbers of the valid memory cell sets for storing cold data in the plurality of virtual blocks to be collected is greater than or equal to the number of memory cell sets of a target virtual block, that is, if one target virtual block can be fully filled with the valid memory cell sets for storing cold data in the plurality of virtual blocks to be collected, fill the target virtual block with the valid memory cell sets for storing cold data in the plurality of virtual blocks to be collected. In this way, the cold data stored in the plurality of virtual blocks to be collected can be gathered into one target virtual block, so that the cold data and the hot data can be stored separately, thus realizing hot and cold separation for the data stored in the memory by using the garbage collection process, and further improving the durability of the memory and keeping the writing performance of the memory after long-time use.

In some implementations, the above operation method also includes determining collection priorities of the various virtual blocks to be collected according to the numbers of the valid memory cell sets in the various virtual blocks to be collected.

Here, as the number of valid memory cell sets in a virtual block to be collected decreases, the collection priority of the virtual block to be collected increases. It should be noted that a virtual block to be collected with a small number of valid memory cell sets can be preferentially selected for garbage collection. Smaller the number of valid memory cell sets in a virtual block to be collected is smaller, smaller the number of valid memory cell sets to be moved is, and faster the releasing of the virtual block to be collected is.

VPC_All shown in FIG. 6 refers to the number of valid memory cell sets in a memory virtual block; VPC_VB refers to the number of memory cell sets in the memory virtual block; and VPC_cold refers to the number of valid memory cell sets for storing cold data in the memory virtual block.

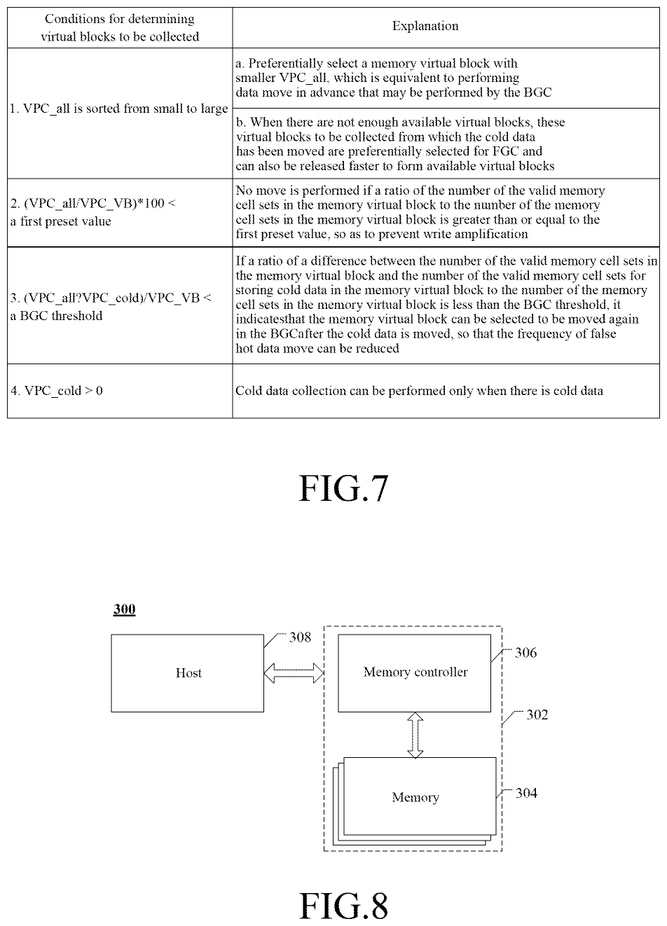

Conditions that need to be considered for determining the virtual blocks to be collected in the memory virtual block will be described in detail below in combination with FIG. 7.

Referring to FIG. 7, FIG. 7 is a schematic diagram of determining virtual blocks to be collected provided by an implementation of the present disclosure. As shown in FIG. 7, the following four conditions need to be considered for determining the virtual blocks to be collected in the memory virtual block: (1) VPC_All is sorted from small to large; (2) (VPC_all/VPC_VB)*100 is less than a first preset value; (3) (VPC_all−VPC_cold)/VPC_VB is less than a background garbage collection threshold; and (4) VPC_cold is greater than 0.

In this implementation of the present disclosure, the first condition needing to be considered for determining the virtual blocks to be collected in the memory virtual block includes the following steps of acquiring the number of valid memory cell sets in a memory virtual block, and determining the plurality of virtual blocks to be collected from the memory virtual block according to the number of the valid memory cell sets in the memory virtual block.

Here, the number (i.e., VPC_all) of valid memory cell sets in the memory virtual block is acquired; the number of the valid memory cell sets in the memory virtual block is sorted from small to large; and smaller the number of the valid memory cell sets in the memory virtual block is, smaller the number of valid memory cell sets to be moved is, and faster the releasing of the virtual block to be collected is. Therefore, a memory virtual block with a small number of valid memory cell sets can be preferentially selected for cold data collection, that is, the memory virtual block with a small number of valid memory cell sets can be determined as the virtual block to be collected.

It should be noted that the garbage collection can be divided into Foreground Garbage Collection (FGC) and Background Garbage Collection (BGC) according to different timings of garbage collection. The FGC means that when a user writes data, if available memory blocks is less than a certain threshold, garbage collection needs to be performed to vacate a space for the user to write data. The FGC is a passive garbage collection method, because it is performed only when there are few memory blocks available in the memory. The BGC is performed actively by the memory when the memory is idle, so that there are a plenty of available memory blocks when the user writes data, thus improving user's write performance.

As mentioned above, it is preferred to select a memory virtual block with a small number of valid memory cell sets for cold data collection, which is equivalent to performing data move in advance that may be performed by the BGC.

In addition, when the available virtual blocks are not enough for the user to write data, these virtual blocks to be collected from which the cold data has been moved are preferentially selected for FGC. This mainly takes into account that the cold data stored in these virtual blocks to be collected has been moved, and the volume of remaining data (i.e. hot data) stored in these virtual blocks to be collected is smaller, which can release these virtual blocks to be collected faster to form available virtual blocks.

In this implementation of the present disclosure, the second condition needing to be considered for determining the virtual blocks to be collected in the memory virtual block includes the following steps of acquiring the number of valid memory cell sets in a memory virtual block, and determining the plurality of virtual blocks to be collected from the memory virtual block according to a first ratio of the number of the valid memory cell sets in the memory virtual block to the number of memory cell sets in the memory virtual block.

In some implementations, the determine the plurality of virtual blocks to be collected from the memory virtual block according to a first ratio of the number of the valid memory cell sets in the memory virtual block to the number of memory cell sets in the memory virtual block includes, if the first ratio is less than a first preset value, determine the memory virtual block as the virtual block to be collected.

Here, the number (i.e. VPC_all) of the valid memory cell sets in the memory virtual block and the number (i.e. VPC_VB) of the memory cell sets in the memory virtual block are acquired; the first ratio (i.e. VPC_all/VPC_VB) of the number of the valid memory cell sets in the memory virtual block to the number of the memory cell sets in the memory virtual block is determined, if the first ratio is less than the first preset value, the memory virtual block is determined as the virtual block to be collected, and if the first ratio is greater than or equal to the first preset value, the memory virtual block is not determined as the virtual block to be collected. In one specific example, the first preset value may be 95%.

It should be noted that a memory virtual block with a small number of valid memory cell sets can be preferentially selected for garbage collection; if the first ratio of the number of the valid memory cell sets in the memory virtual block to the number of memory cell sets in the memory virtual block is greater than or equal to the first preset value (for example, 95%), it indicates that the number of the valid memory cell sets in the memory virtual block is large, and one target virtual block will be possibly occupied even if the garbage collection is performed; at this time, the garbage collection will occupy one target virtual block while releasing one memory virtual block; therefore, the effect of garbage collection is not obvious at this time. In addition, larger the number of the valid memory cell sets in the memory virtual block is, more data needs to be moved; and therefore, greater the write amplification caused by garbage collection is.

In addition, if the number of the valid memory cell sets in the memory virtual block is large, more data needs to be moved, so the memory virtual block cannot be released as fast as possible.

In this implementation of the present disclosure, the third condition needing to be considered for determining the virtual blocks to be collected in the memory virtual block includes the following steps of acquiring the number of valid memory cell sets in a memory virtual block and the number of valid memory cell sets for storing cold data in the memory virtual block, and determining the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

In some implementations, the determine the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block includes, if the second ratio is less than a BGC threshold, the memory virtual block is determined as the virtual block to be collected.

The number (i.e., VPC_all) of the valid memory cell sets in the memory virtual block, the number (i.e., VPC_cold) of the valid memory cell sets for storing cold data in the memory virtual block and the number (i.e., VPC_VB) of the memory cell sets in the memory virtual block are acquired; the second ratio of the difference between the number of the valid memory cell sets in the memory virtual block and the number of the valid memory cell sets for storing cold data in the memory virtual block to the number of the memory cell sets in the memory virtual block is determined; if the second ratio is less than the BGC threshold, the memory virtual block is determined as the virtual block to be collected; and if the second ratio is greater than or equal to the BGC threshold, the memory virtual block is not determined as the virtual block to be collected. In one specific example, the BGC threshold can be 70%.

It should be noted that the difference between the number of the valid memory cell sets in the memory virtual block and the number of the valid memory cell sets for storing cold data in the memory virtual block is the number of valid memory cell sets for storing hot data in the memory virtual block after the valid memory cell sets for storing cold data are moved; further, if the second ratio of the number of the valid memory cell sets for storing hot data in the memory virtual block to the number of the memory cell sets in the memory virtual block is less than the BGC threshold, the BGC can be triggered. In this way, after cold data of the memory virtual block is moved, the BGC can be continued, that is, hot data can be continued to be moved. That is, for the memory virtual block from which the cold data has been moved, the second ratio is more likely to be less than the BGC threshold, and the BGC is more likely to be triggered. In this way, the frequency of false hot data move can be reduced.

In this implementation of the present disclosure, the fourth condition needing to be considered for determining the virtual blocks to be collected in the memory virtual block includes the following steps of acquiring the number of valid memory cell sets for storing cold data in a memory virtual block, and determining the plurality of virtual blocks to be collected from the memory virtual block according to the number of the valid memory cell sets for storing cold data in the memory virtual block.

Here, the number (i.e., VPC_cold) of valid memory cell sets for storing cold data in the memory virtual block is acquired, and if the number of the valid memory cell sets for storing cold data in the memory virtual block is greater than 0, that is, only if the memory virtual block includes a valid memory cell set for storing cold data, cold data can be collected.

An implementation of the present disclosure provides a memory controller. The memory controller is configured to provide a plurality of virtual blocks to be collected, acquire identification information of valid memory cell sets in the virtual blocks to be collected, determine valid memory cell sets for storing cold data in the virtual blocks to be collected according to the identification information, wherein the identification information includes hot and cold attributes indicating stored data in the valid memory cell sets, and, if the sum of the numbers of the valid memory cell sets for storing cold data in the plurality of virtual blocks to be collected is greater than or equal to the number of memory cell sets of a target virtual block, fill the target virtual block with cold data of the valid memory cell sets in the plurality of virtual blocks to be collected.

In this implementation of the present disclosure, a processing apparatus of data can be used for processing the stored data in the memory. Therefore, the processing apparatus of data can include the memory controller.

In some implementations, the memory controller is configured to acquire logic cell address and corresponding physical cell addresses of memory cell sets in the virtual blocks to be collected, and determine the valid memory cell sets from the memory cell sets in the virtual blocks to be collected according to the PCAs.

In some implementations, the memory controller is configured to determine collection priorities of the various virtual blocks to be collected according to the numbers of the valid memory cell sets in the various virtual blocks to be collected.

In some implementations, the memory controller is configured to acquire the number of valid memory cell sets in a memory virtual block, and determine the plurality of virtual blocks to be collected from the memory virtual block according to the number of the valid memory cell sets in the memory virtual block.

In some implementations, the memory controller is configured to acquire the number of valid memory cell sets in a memory virtual block, and determine the plurality of virtual blocks to be collected from the memory virtual block according to a first ratio of the number of the valid memory cell sets in the memory virtual block to the number of memory cell sets in the memory virtual block.

In some implementations, the memory controller is configured to, if the first ratio is less than a first preset value, determine the memory virtual block as the virtual block to be collected.

In some implementations, the memory controller is configured to acquire the number of valid memory cell sets in a memory virtual block and the number of valid memory cell sets for storing cold data in the memory virtual block, and determine the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

In some implementations, the memory controller is configured to, if the second ratio is less than a BGC threshold, determine the memory virtual block as the virtual block to be collected.

In some implementations, the valid memory cell sets include a first valid memory cell subset and a second valid memory cell subset, and the first valid memory cell subset is used for storing user data, and the second valid memory cell subset is used for storing the identification information.

An implementation of the present disclosure further provides a processing method of data. The processing method includes providing a plurality of virtual blocks to be collected, acquiring identification information of valid memory cell sets in the virtual blocks to be collected, determining valid memory cell sets for storing cold data in the virtual blocks to be collected according to the identification information, wherein the identification information comprises hot and cold attributes indicating stored data in the valid memory cell sets, and, if the sum of the numbers of the valid memory cell sets for storing cold data in the plurality of virtual blocks to be collected is greater than or equal to the number of memory cell sets of a target virtual block, fill the target virtual block with cold data of the valid memory cell sets in the plurality of virtual blocks to be collected.

In some implementations, before the acquiring identification information of valid memory cell sets in the virtual blocks to be collected, the processing method further includes acquiring logic cell address and corresponding physical cell addresses of memory cell sets in the virtual blocks to be collected, and determining the valid memory cell sets from the memory cell sets in the virtual blocks to be collected according to the physical cell addresses.

In some implementations, the processing method further includes determining collection priorities of the various virtual blocks to be collected according to the numbers of the valid memory cell sets in the various virtual blocks to be collected.

In some implementations, before the providing a plurality of virtual blocks to be collected, the processing method further includes acquiring the number of valid memory cell sets in a memory virtual block, and determine the plurality of virtual blocks to be collected from the memory virtual block according to the number of the valid memory cell sets in the memory virtual block.

In some implementations, before the providing a plurality of virtual blocks to be collected, the processing method further includes acquiring the number of valid memory cell sets in a memory virtual block, and determining the plurality of virtual blocks to be collected from the memory virtual block according to a first ratio of the number of the valid memory cell sets in the memory virtual block to the number of memory cell sets in the memory virtual block.

In some implementations, the determining the plurality of virtual blocks to be collected from the memory virtual block according to a first ratio of the number of the valid memory cell sets in the memory virtual block to the number of memory cell sets in the memory virtual block includes, if the first ratio is less than a first preset value, determine the memory virtual block as the virtual block to be collected.

In some implementations, before the providing a plurality of virtual blocks to be collected, the processing method further includes acquiring the number of valid memory cell sets in a memory virtual block and the number of valid memory cell sets for storing cold data in the memory virtual block, and determining the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

In some implementations, the determine the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block includes, if the second ratio is less than a background garbage collection threshold, determining the memory virtual block as the virtual block to be collected.

In some implementations, the valid memory cell sets include a first valid memory cell subset and a second valid memory cell subset; and the first valid memory cell subset is used for storing user data, and the second valid memory cell subset is used for storing the identification information.

An implementation of the present disclosure further provides a processing apparatus of data. The processing apparatus includes an acquisition module, used to acquire identification information of valid memory cell sets in the plurality of virtual blocks to be collected, a selection module, used to determine valid memory cell sets for storing cold data in the virtual blocks to be collected according to the identification information, wherein the identification information includes hot and cold attributes indicating stored data in the valid memory cell sets, and a filling module, used to, if the sum of the numbers of the valid memory cell sets for storing cold data in the plurality of virtual blocks to be collected is greater than or equal to the number of memory cell sets of a target virtual block, fill the target virtual block with cold data of the valid memory cell sets in the plurality of virtual blocks to be collected.

In some implementations, the processing apparatus further includes a first acquisition module, used to acquire logic cell address and corresponding physical cell addresses of memory cell sets in the virtual blocks to be collected, and a first determining module, used to determine the valid memory cell sets from the memory cell sets in the virtual blocks to be collected according to the physical cell addresses.

In some implementations, the processing apparatus further includes a sorting module, used to determine collection priorities of the various virtual blocks to be collected according to the numbers of the valid memory cell sets in the various virtual blocks to be collected.

In some implementations, the processing apparatus further includes a second acquisition module, used to acquire the number of valid memory cell sets in a memory virtual block, and a second determining module, used to determine the plurality of virtual blocks to be collected from the memory virtual block according to the number of the valid memory cell sets in the memory virtual block.

In some implementations, the processing apparatus further includes a third acquisition module, used to acquire the number of valid memory cell sets in a memory virtual block, and a third determining module, used to determine the plurality of virtual blocks to be collected from the memory virtual block according to a first ratio of the number of the valid memory cell sets in the memory virtual block to the number of memory cell sets in the memory virtual block.

In some implementations, the third determining module is also used to, if the first ratio is less than a first preset value, determine the memory virtual block as the virtual block to be collected.

In some implementations, the processing apparatus further includes a fourth acquisition module, used to acquire the number of valid memory cell sets in a memory virtual block and the number of valid memory cell sets for storing cold data in the memory virtual block, and a fourth determining module, used to determine the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

In some implementations, the fourth determining module is also used to, if the second ratio is less than a background garbage collection threshold, determine the memory virtual block as the virtual block to be collected.

In some implementations, the valid memory cell sets include a first valid memory cell subset and a second valid memory cell subset; and the first valid memory cell subset is used for storing user data; and the second valid memory cell subset is used for storing the identification information.

An implementation of the present disclosure also provides a memory system. The memory system includes a memory and the memory controller in the above-mentioned technical solution.

Referring to FIG. 8, FIG. 8 is a schematic diagram of a memory system provided by an implementation of the present disclosure. As shown in FIG. 8, the memory system 300 includes a memory 304; and a memory controller 306, coupled to the memory 304 and configured to control the memory 304.

The memory system 300 may be a mobile phone, a desktop computer, a laptop, a tablet, a vehicle computer, a game console, a printer, a positioning device, a wearable electronic device, an intelligent sensor, a Virtual Reality (VR) device, an Augmented Reality (AR) device, or any other suitable electronic devices with storages therein.

As shown in FIG. 8, the memory system 300 can include a host 308 and a memory subsystem 302, the memory subsystem 302 has one or more memories 304, and the memory subsystem also includes a memory controller 306. The host 308 may be a processor of an electronic device (for example, a Central Processing Unit (CPU)) or a System on Chip (SoC) (for example, an Application Processor (AP)). The host 308 may be configured to transmit data to the memory 304. Or, the host 308 may be configured to receive data from the memory 304.

The memory 304 may be a NAND flash memory (for example, a three-dimensional (3D) NAND flash memory). The memory 304 may have a reduced leakage current from a drive transistor (for example, a string drive) coupled to an unselected word line during an erase operation, which allows a further reduction in the size of the drive transistor.

In some implementations, the memory controller 306 is also coupled to the host 308. The memory controller 306 may manage the data stored in the memory 304 and communicate with the host 308.

In some implementations, the memory controller 306 is designed to be operated in a low duty cycle environment, such as a Secure Digital (SD) card, a Compact Flash (CF) card, a Universal Serial Bus (USB) flash drive, or other media used in an electronic device such as a personal calculator, a digital camera, and a mobile phone, etc.

In some implementations, the memory controller 306 is designed to be operated in a high duty cycle environment, such as a Solid State Drive (SSD) or embedded Multi-Media Card (eMMC), and the SSD or eMMC is used as a data storage and enterprise storage array of a mobile device such as a smart phone, a tablet and a laptop.

The memory controller 306 may be configured to control operations of the memory 304, such as read, erase, and programming operations. The memory controller 306 may also be configured to manage various functions regarding data stored or to be stored in the memory 304, including but not limited to bad block management, garbage collection, logic to physical cell address translation, wear leveling, and the like. In some implementations, the memory controller 306 is also configured to process Error Correction Codes (ECCs) on data read from or written to the memory 304.

The memory controller 306 may also perform any other suitable functions, such as formatting the memory 304. The memory controller 306 may communicate with an external device (for example, the host 308) according to a specific communication protocol. For example, the memory controller 306 can communicate with external devices through at least one of various interface protocols, such as a USB protocol, an MMC protocol, a Peripheral Component Interconnection (PCI) protocol, a PCI Express (PCI-E) protocol, an Advanced Technology Attachment (ATA) protocol, a serial ATA protocol, a parallel ATA protocol, a Small Computer Small Interface (SCSI) protocol, an Enhanced Small Disk Interface (ESDI) protocol, an Integrated Drive Electronics (IDE) protocol, and a Firewire protocol.

The memory controller 306 and one or more memories 304 may be integrated into various types of storage devices, for example, in the same package (for example, a Universal Flash Storage (UFS) package or an eMMC package). That is, the memory system 300 can be implemented and packaged to different types of terminal electronic products.

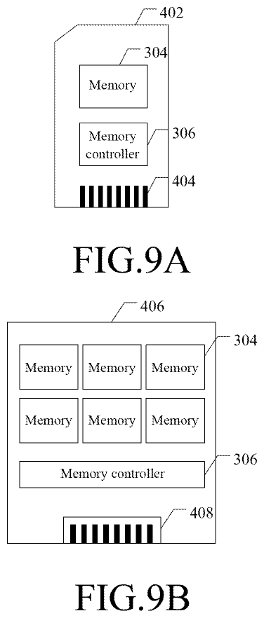

In one example as shown in FIG. 9A, the memory controller 306 and a single memory 304 may be integrated into a memory card 402. The memory card 402 may include a PC card (PCMCIA, Personal Computer Memory Card International Association), a CF card, a Smart Media (SM) card, a memory stick, a multimedia card (MMC. RS-MMC, MMC micro), an SD card (SD, miniSD, microSD, SDHC), a UFS, and the like. The memory card 402 may also include a memory card connector 404 that couples the memory card 402 with a host (for example, the host 308 in FIG. 8).

In another example as shown in FIG. 9B, the memory controller 306 and a plurality of memories 304 may be integrated into a solid state drive 406. The solid state drive 406 may also include a solid state drive connector 408 that couples the solid state drive 406 with a host (for example, the host 308 in FIG. 8). In some implementations, the storage capacity and/or operation speed of the solid state drive 406 are greater than those of the memory card 402.

It can be understood that the memory controller 306 may perform the operation method as provided in any implementation of the present disclosure.

An implementation of the present disclosure also provides a non-transitory computer-readable storage medium which stores a computer program, which, when executed, may implement the operation method in the above technical solution.

In this implementation of the present disclosure, the computer-readable storage medium may include a Random Access Memory (RAM), an internal memory, a Read-Only Memory (ROM), an electrically programmable ROM, an electrically erasable programmable ROM, a register, a hard disk, a mobile disk, a CD-ROM or program code media in any other foul's known in the technical field.

An implementation of the present disclosure also provides an electronic device, which includes the memory system in the above technical solution. The electronic device includes a cellphone, a desktop computer, a tablet, a laptop, a server, a vehicle-mounted device, a wearable device or a mobile power supply.

Implementations of the present disclosure provide a memory controller and an operation method thereof, a memory system and an electronic device. The operation method includes: providing a plurality of virtual blocks to be collected; acquiring identification information of valid memory cell sets in the virtual blocks to be collected; determining valid memory cell sets for storing cold data in the virtual blocks to be collected according to the identification information, wherein the identification information includes hot and cold attributes indicating stored data in the valid memory cell sets; and if the sum of the numbers of the valid memory cell sets for storing cold data in the plurality of virtual blocks to be collected is greater than or equal to the number of memory cell sets of a target virtual block, filling the target virtual block with cold data of the valid memory cell sets in the plurality of virtual blocks to be collected.

In the implementations of the present disclosure, in a garbage collection process, a distribution of the cold data in the virtual blocks to be collected is analyzed; under the condition of satisfying that one target virtual block can be fully filled with the cold data stored in the plurality of virtual blocks to be collected, the target virtual block is filled with the cold data stored in the plurality of virtual blocks to be collected (that is, the cold data is gathered), so that the cold data and hot data in a memory can be separately stored, thus realizing hot and cold separation for the data stored in the memory by using the garbage collection process, and further improving the durability of the memory and keeping the writing performance of the memory after long-time use.

It should be understood that “one implementation” or “an implementation” mentioned throughout the specification mean that specific features, structures or characteristics related to the implementations are included in at least one implementation of the present disclosure. Therefore, “in one implementation” or “in an implementation” appearing in throughout the specification does not necessarily mean the same implementation. In addition, these specific features, structures or characteristics may be combined in one or more implementations in any proper manner. It should be understood that in various implementations of the present disclosure, the serial numbers of the above various processes do not mean the order of execution. The order of execution of the various processes shall be determined by their functions and an internal logic, and shall not constitute any limitations to the implementation processes of the implementations of the present disclosure. The sequential numbers of the above-mentioned implementations of the present disclosure are only for description, and do not represent the advantages or disadvantages of the implementations.

The above descriptions are only preferred implementations of the present disclosure, and are not intended to limit the patent scope of the present disclosure. Any equivalent structural transformation made by using the content of the specification and the drawings of the present disclosure under the inventive concept of the present disclosure, or directly or indirectly application to other related technical fields shall all be included in the scope of patent protection of the present disclosure.

1. A method for operating a memory controller, the method comprising:
providing a plurality of virtual blocks to be collected;
acquiring identification information of valid memory cell sets in the virtual blocks to be collected;
determining valid memory cell sets for storing cold data in the virtual blocks to be collected according to the identification information, wherein the identification information comprises hot and cold attributes indicating stored data in the valid memory cell sets; and
if the sum of the numbers of the valid memory cell sets for storing cold data in the plurality of virtual blocks to be collected is greater than or equal to the number of memory cell sets of a target virtual block, filling the target virtual block with cold data of the valid memory cell sets in the plurality of virtual blocks to be collected.

2. The method for operating the memory controller of claim 1, wherein before the acquiring identification information of valid memory cell sets in the virtual blocks to be collected, the operation method further comprises:
acquiring logic cell address and corresponding physical cell addresses of memory cell sets in the virtual blocks to be collected; and
determining the valid memory cell sets from the memory cell sets in the virtual blocks to be collected according to the physical cell addresses.

3. The method for operating the memory controller of claim 1, further comprising:
determining collection priorities of the various virtual blocks to be collected according to the numbers of the valid memory cell sets in the various virtual blocks to be collected.

4. The method for operating the memory controller of claim 1, wherein before the providing the plurality of virtual blocks to be collected, the operation method further comprises:
acquiring the number of valid memory cell sets in a memory virtual block; and
determining the plurality of virtual blocks to be collected from the memory virtual block according to the number of the valid memory cell sets in the memory virtual block.

5. The method for operating the memory controller of claim 1, wherein before the providing the plurality of virtual blocks to be collected, the operation method further comprises:
acquiring the number of valid memory cell sets in a memory virtual block; and
determining the plurality of virtual blocks to be collected from the memory virtual block according to a first ratio of the number of the valid memory cell sets in the memory virtual block to the number of memory cell sets in the memory virtual block.

6. The method for operating the memory controller of claim 5, wherein the determining the plurality of virtual blocks to be collected from the memory virtual block according to the first ratio of the number of the valid memory cell sets in the memory virtual block to the number of memory cell sets in the memory virtual block further comprises:
if the first ratio is less than a first preset value, determining the memory virtual block as the virtual block to be collected.

7. The method for operating the memory controller of claim 1, wherein before the providing the plurality of virtual blocks to be collected, the operation method further comprises:
acquiring the number of valid memory cell sets in a memory virtual block and the number of valid memory cell sets for storing cold data in the memory virtual block; and
determining the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

8. The method for operating the memory controller of claim 7, wherein the determining the plurality of virtual blocks to be collected from the memory virtual block according to the second ratio of the difference between the number of the valid memory cell sets in the memory virtual block and the number of the valid memory cell sets for storing cold data in the memory virtual block to the number of memory cell sets in the memory virtual block further comprises:
if the second ratio is less than a background garbage collection threshold, determining the memory virtual block as the virtual block to be collected.

9. The method for operating the memory controller of claim 1, wherein:
the valid memory cell sets include a first valid memory cell subset and a second valid memory cell subset, and
the first valid memory cell subset is used for storing user data; and the second valid memory cell subset is used for storing the identification information.

10. A memory controller, wherein the memory controller is configured to:
provide a plurality of virtual blocks to be collected;
acquire identification information of valid memory cell sets in the virtual blocks to be collected;
determine valid memory cell sets for storing cold data in the virtual blocks to be collected according to the identification information, wherein the identification information comprises hot and cold attributes indicating stored data in the valid memory cell sets; and
if the sum of the numbers of the valid memory cell sets for storing cold data in the plurality of virtual blocks to be collected is greater than or equal to the number of memory cell sets of a target virtual block, fill the target virtual block with cold data of the valid memory cell sets in the plurality of virtual blocks to be collected.

11. The memory controller of claim 10 that is further configured to:
acquire logic cell address and corresponding physical cell addresses of memory cell sets in the virtual blocks to be collected; and
determine the valid memory cell sets from the memory cell sets in the virtual blocks to be collected according to the physical cell addresses.

12. The memory controller of claim 10 that is further configured to:
determine collection priorities of the various virtual blocks to be collected according to the numbers of the valid memory cell sets in the various virtual blocks to be collected.

13. The memory controller of claim 10 that is further configured to:
acquire the number of valid memory cell sets in a memory virtual block; and
determine the plurality of virtual blocks to be collected from the memory virtual block according to the number of the valid memory cell sets in the memory virtual block.

14. The memory controller of claim 10 that is further configured to:
acquire the number of valid memory cell sets in a memory virtual block; and
determine the plurality of virtual blocks to be collected from the memory virtual block according to a first ratio of the number of the valid memory cell sets in the memory virtual block to the number of memory cell sets in the memory virtual block.

15. The memory controller of claim 14 that is further configured to:
if the first ratio is less than a first preset value, determine the memory virtual block as the virtual block to be collected.

16. The memory controller of claim 10 that is further configured to:
acquire the number of valid memory cell sets in a memory virtual block and the number of valid memory cell sets for storing cold data in the memory virtual block; and
determine the plurality of virtual blocks to be collected from the memory virtual block according to a second ratio of a difference between the number of the valid memory cell sets in the memory virtual block and the number of the valid memory cell sets for storing cold data in the memory virtual block to the number of memory cell sets in the memory virtual block.

17. The memory controller of claim 16 that is further configured to:
if the second ratio is less than a background garbage collection threshold, determine the memory virtual block as the virtual block to be collected.

18. The memory controller of claim 10, wherein:
the valid memory cell sets includes a first valid memory cell subset and a second valid memory cell subset; and
the first valid memory cell subset is used for storing user data; and the second valid memory cell subset is used for storing the identification information.

19. A memory system that comprises a memory and memory controller, wherein the memory controller is configured to:
provide a plurality of virtual blocks to be collected;
acquire identification information of valid memory cell sets in the virtual blocks to be collected;
determine valid memory cell sets for storing cold data in the virtual blocks to be collected according to the identification information, wherein the identification information comprises hot and cold attributes indicating stored data in the valid memory cell sets; and
if the sum of the numbers of the valid memory cell sets for storing cold data in the plurality of virtual blocks to be collected is greater than or equal to the number of memory cell sets of a target virtual block, fill the target virtual block with cold data of the valid memory cell sets in the plurality of virtual blocks to be collected.

20. An electronic device that comprises the memory system of claim 19.
